(19) United States
(12) Patent Application Publication
(10) Pub. No.: US 2026/0336161 A1
(43) Pub. Date: Oct. 29, 2026

(54) CONCRETE BLOCK APPARATUS FOR ASH SLAG AFTER COAL GASIFICATION

(71) Applicant: Northeastern University, Shenyang (CN)

(72) Inventors: Xiaowei GU, Shenyang (CN); Xiaowei GE, Shenyang (CN); Xiaochuan XU, Shenyang (CN); Fengdan WANG, Shenyang (CN); Shenyu WANG, Shenyang (CN); Ziyang HU, Shenyang (CN); Xu WANG, Shenyang (CN); Zhihang HU, Shenyang (CN); Bohan YANG, Shenyang (CN); Jianping LIU, Shenyang (CN); Qing WANG, Shenyang (CN); Hao WANG, Shenyang (CN)

(21) Appl. No.: 19/700,217

(22) Filed: Jun. 6, 2026

(30) Foreign Application Priority Data
Sep. 29, 2025 (CN) 202511415172.X

(51) Int. Cl. B28B 7/38; B28B 7/00; B28B 7/26; B28B 13/00

(52) U.S. Cl. CPC B28B 7/38; B28B 7/0014; B28B 7/26; B28B 13/00

(57) ABSTRACT

The present disclosure discloses a concrete block apparatus for ash slag after coal gasification. The present disclosure relates to the field of ash slag concrete processing technology after coal gasification. including an apparatus; the first connecting frame is installed on the outside of the apparatus; the chute is opened in the interior of the apparatus; the first chute board is connected to the inside of the chute; the moving mechanism is connected to the first connecting frame, the moving mechanism includes the second chute board and the third chute board, the external of the second chute board and the third chute board is provided with a moving frame, the second chute board and the third chute board are used to control the moving frame in and out of the apparatus, the placing mechanism is connected to the moving mechanism.

### TECHNICAL FIELD

The present disclosure relates to the field of ash slag concrete processing technology after coal gasification, specifically a concrete block apparatus for ash slag after coal gasification.

### BACKGROUND

Ash slag concrete derived from coal gasification is a specialized concrete material that uses solid waste, specifically ash generated during the coal gasification process, as its primary admixture. Its core principle lies in replacing a portion of cement or aggregate with ash, thereby enabling the utilization of industrial solid waste as a resource and contributing to the development of green building materials.

In the invention CN107672023A, a concrete block forming machine is disclosed. In this system, mixed concrete is pumped out by a pump controlled via a controller inside an electrical control box, and the concrete is applied to the block forming mold using a manual hand-held nozzle. Once the concrete has been added, the controller within the electrical control box activates a third motor, which drives a second screw to rotate, thereby moving a connecting plate up and down. This mechanism allows an extrusion plate located on the underside of the connecting plate to effectively compact the concrete within the block-forming mold, enabling the apparatus to complete the molding of multiple blocks in a single operation and thereby improving its working efficiency. However, when an integrated mold is used in the block forming apparatus, the release agent applied inside the mold gradually flows downward toward the bottom, resulting in an excessive accumulation of release agent at the bottom of the mold, which can easily lead to issues during the molding of the lower part of the blocks.

### SUMMARY

In order to overcome the problem that the integrated mold is set in the block apparatus, when the demoulding agent is applied, the demoulding agent in the mold gradually flows to the bottom, resulting in too much demoulding agent at the bottom of the mold, which is easy to cause problems at the bottom of the block during molding, the present disclosure provides a concrete block apparatus for ash slag after coal gasification, including an apparatus;
a first connecting frame, the first connecting frame is installed outside the apparatus;
a chute, the chute is opened inside the apparatus;
a first chute board, the first chute board is in a sliding connection to an interior of the chute;
a moving mechanism, the moving mechanism is connected to the first connecting frame; the moving mechanism includes a second chute board and a third chute board; the second chute board and the third chute board are equipped with a moving frame; the second chute board and the third chute board are configured to control the moving frame to enter and exit the apparatus;
a placing mechanism, the placing mechanism is connected to the moving mechanism; the placing mechanism includes a placing frame; a fixed groove is arranged inside the placing frame, and the first lifting frame is installed inside the fixed groove;
a processing mechanism, the processing mechanism is connected to the first chute board, the processing mechanism includes a mobile station; a fifth push rod is arranged below the mobile station; a bottom of the fifth push rod is equipped with a contact component, the fifth push rod is configured to control a contact between the contact component and the placing mechanism.

In some embodiments, the moving mechanism also includes:
a telescopic rod, the telescopic rod is installed between the second chute board and the third chute board;
a first outer ring, two first outer rings are provided, one of which is installed outside the second chute board, and the other is installed outside the third chute board;
a connecting tube, two connecting tubes are provided, two connecting tubes are respectively connected inside two first outer rings in a manner of rotation, and the connecting tube is connected to the moving frame.

In some embodiments, the moving mechanism also includes:
a connecting shaft, the connecting shaft is connected to the moving frame;
a fourth chute board, the fourth chute board is connected to an interior of the first connecting frame, and two fourth chute boards are provided;
a second outer ring, the second outer ring is installed outside the fourth chute board, and the connecting shaft is connected inside the second outer ring in a manner of rotation.

In some embodiments, the moving mechanism also includes:
a channel, the channel is opened in the interior of the connecting frame;
a mounting frame, the mounting frame is installed outside the connecting frame;
a first motor cabinet, the first motor cabinet is arranged above the mounting frame, and the first motor is arranged inside the first motor cabinet;
a first push rod, the first push rod is connected to an output end of the first motor.

In some embodiments, the placing mechanism also includes:
a second push rod, the second push rod is arranged inside the moving frame;
a moving frame, the moving frame is connected to a telescopic end of the second push rod, the moving frame is connected to the placing frame, and multiple placing frames are provided;
an adjusting rod, the adjusting rod is installed between two moving frames.

In some embodiments, the placing mechanism also includes:
a first groove, the first groove is opened inside the placing frame;
a supporting plate, the supporting plate is installed in an interior of the first groove, and two supporting plates are provided in a symmetrical setting;
a third push rod, the third push rod is installed inside the placing frame, and a telescopic end of the third push rod is installed with a pad;
a second groove, the second groove is opened in an interior of the first lifting frame;
a lower die, the lower die is installed inside the second groove.

In some embodiments, the processing mechanism also includes:
a second connecting frame, the second connecting frame is connected to the first sliding plate, and the mobile station is in a sliding connection inside the second connecting frame;
a fourth push rod, the fourth push rod is installed inside the second connecting frame, and a telescopic end of the fourth push rod is connected to the mobile station;
a second motor cabinet, the second motor cabinet is installed at a bottom of the mobile station, the second motor is arranged inside the second motor cabinet, and a fifth push rod is connected to an output end of the second motor.

In some embodiments, the contact component includes:
a connecting plate, the connecting plate is connected to a telescopic end of the fifth push rod.
a sixth push rod, two sixth push rods are arranged, and the two sixth push rods are respectively installed on both sides of the connecting plate.
a side plate, the side plate is connected to a telescopic end of the sixth push rod, and an exterior of the side plate is equipped with an electric push plate.
a connecting rod, the connecting rod is connected to an electric push plate, an exterior of the connecting rod is equipped with a contact plate, and an exterior of the contact plate is provided with a convex.

In some embodiments, the contact component also includes:
an expansion plate, the expansion plate is installed on an exterior of the side plate;
a second lifting frame, the second lifting frame is installed at a bottom of the side plate;
a connecting column, the connecting column is installed at a bottom of the second lifting frame, and multiple connecting columns are provided.

The present disclosure provides a concrete block apparatus for ash slag after coal gasification, it has the following beneficial effects:
1, in the concrete block apparatus for ash slag after coal gasification, the placement mechanism is configured such that the integrated mold is divided into a topless and bottomless frame mold and a vertically adjustable bench. The frame mold and the bench are coated with release agent and demolded separately. In a conventional block apparatus, an integrated mold is used, and when the release agent is applied, it tends to accumulate at the bottom, leading to an excessive concentration that can easily cause defects during block formation. To address this, the block mold is designed as a combination of a topless and bottomless frame mold and a lifting bench. Workers apply the release agent to the upper surface of the bench and the frame mold separately, allowing the release agent to set before the two components are combined, thereby avoiding the aforementioned issue.
2, by incorporating a moving mechanism into the concrete block apparatus for ash slag after coal gasification, the position and angle of the moving frame, along with the material, can be adjusted. The operations of release agent application, material distribution, molding, and discharge are each set up in separate positions to provide adequate working space for operators. The deflection of the moving frame is controlled by a first motor, which regulates the opening direction of the moving frame and thereby controls the discharge position of the block.
3, in the concrete block apparatus for ash slag after coal gasification, a processing mechanism is provided, through which concrete is placed between the lower die and the bench. The processing mechanism, together with a contact component, is used to vibrate the lower die and the bench, facilitating the release of air bubbles from the concrete. After the concrete is formed into blocks, the processing mechanism and the contact component continue to promote vibration of the lower die and the bench, aiding in the separation of the blocks from the mold and bench.
4, in the concrete block apparatus for ash slag after coal gasification, a contact component is employed, after material distribution, a contact plate surrounding the lower die, along with several protrusions, performs uniform vibratory collision work in the horizontal direction around the lower die. Meanwhile, multiple connecting columns at the bottom of the bench perform uniform vibratory collision work in the vertical direction on the underside of the bench. These actions promote uniform distribution within the concrete and facilitate the release of air bubbles. After block formation, the same uniform vibratory collision work is applied around the lower die and at the bottom of the bench to facilitate the separation of the block from the lower die and bench.

### BRIEF DESCRIPTION OF THE DRAWINGS

FIG. 1 is an overall structural diagram of the present disclosure;

FIG. 2 is another perspective structural diagram of the present disclosure;

FIG. 3 is a schematic diagram of the moving mechanism structure of the present disclosure;

FIG. 4 is a structural diagram at A in FIG. 3 of the present disclosure;

FIG. 5 is a structural diagram of the placing mechanism of the present disclosure.

FIG. 6 is a structural diagram at B in FIG. 5 of the present disclosure;

FIG. 7 is a structural diagram of the processing mechanism of the present disclosure;

FIG. 8 is a structural diagram of the contact component of the present disclosure.

FIG. 9 is a structural diagram of another perspective of the contact component of the present disclosure.

Marks in the figures: 1, apparatus; 2, first connecting frame; 3, moving mechanism; 301, second chute board; 302, telescopic rod; 303, third chute board; 304, first outer ring; 305, connecting pipe; 306, moving frame; 307, connecting shaft; 308, second outer ring; 309, fourth chute board; 310, channel; 311, mounting frame; 312, first motor cabinet; 313, first push rod; 4. placing mechanism; 401, second push rod; 402, moving frame; 403, placing box; 404, adjusting rod; 405, first groove; 406, supporting plate; 407, third push rod; 408, fixed groove; 409, first lifting frame; 410, second groove; 411, lower die; 5, chute; 6, first chute board; 7, processing mechanism; 701, second connecting frame; 702, fourth push rod; 703, mobile station; 704, second motor cabinet; 705, fifth push rod; 706, contact component; 7061, connecting plate; 7062, sixth push rod; 7063, side plate; 7064, electric push plate; 7065, connecting rod; 7066, contact plate; 7067, expansion plate; 7068, second lifting frame; 7069, connecting column.

### DETAILED DESCRIPTION

The following is a further detailed description of the present disclosure in combination with the attached diagram and the specific implementation method. The embodiment of the present disclosure is given for illustration and description, and is not exhaustive or limited to the form disclosed. Many modifications and changes are obvious to ordinary technicians in this field. The selection and description of embodiments are to better illustrate the principle and practical application of the present disclosure, and to enable ordinary technicians in this field to understand the present disclosure and design various embodiments with various modifications suitable for specific purposes.

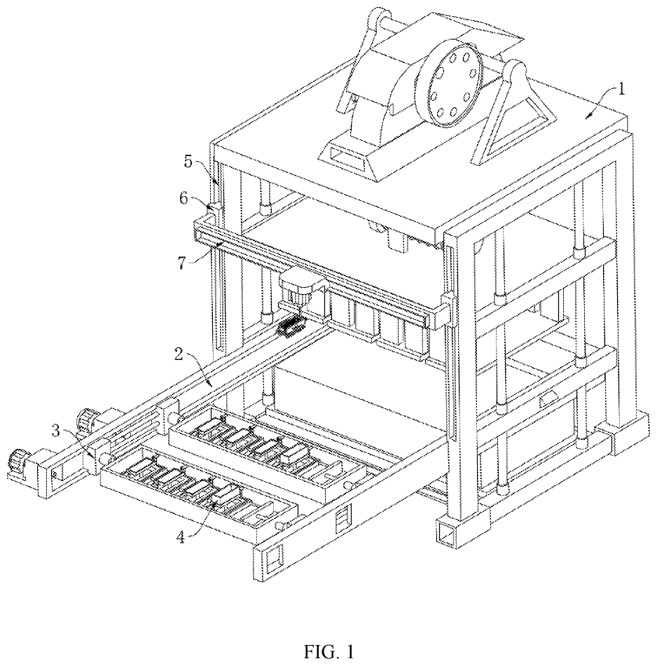

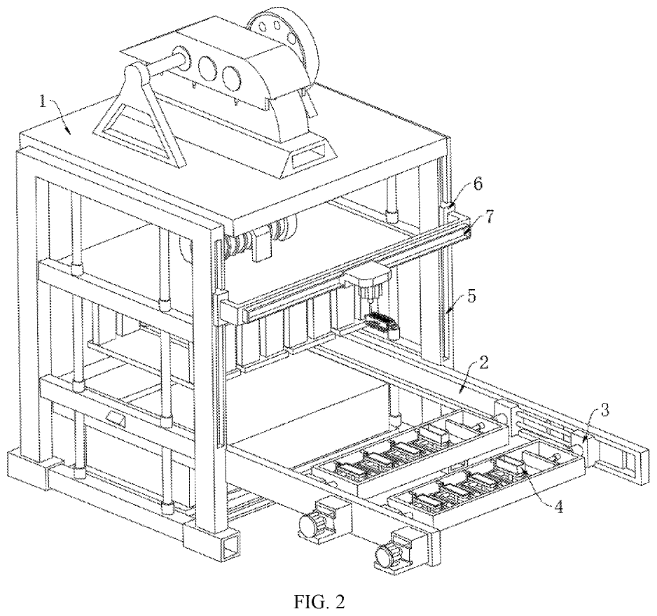

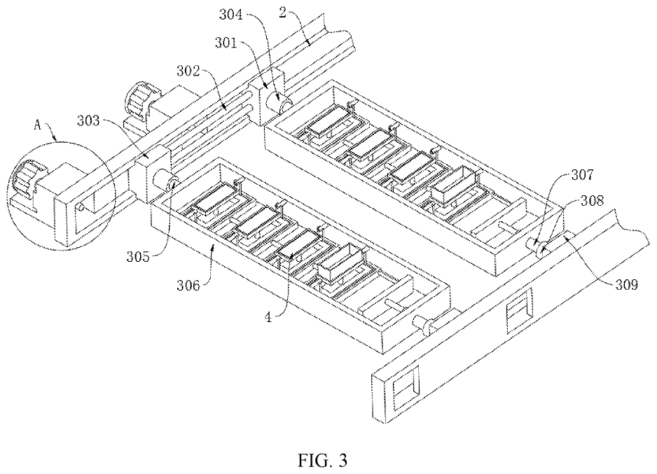

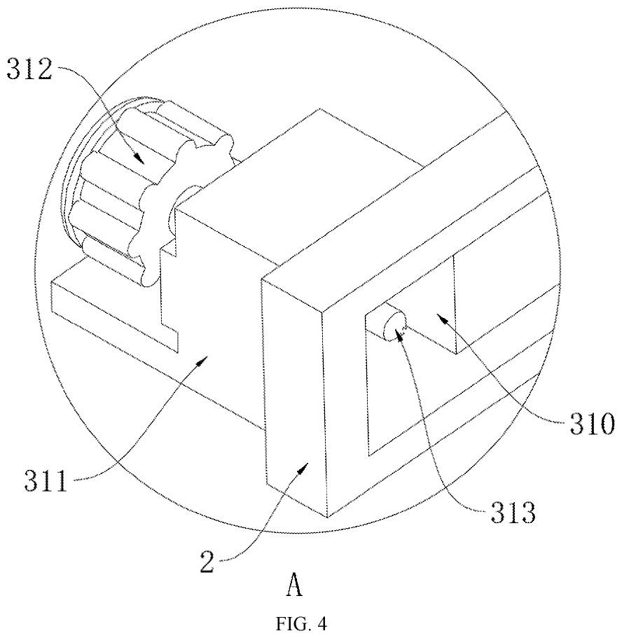

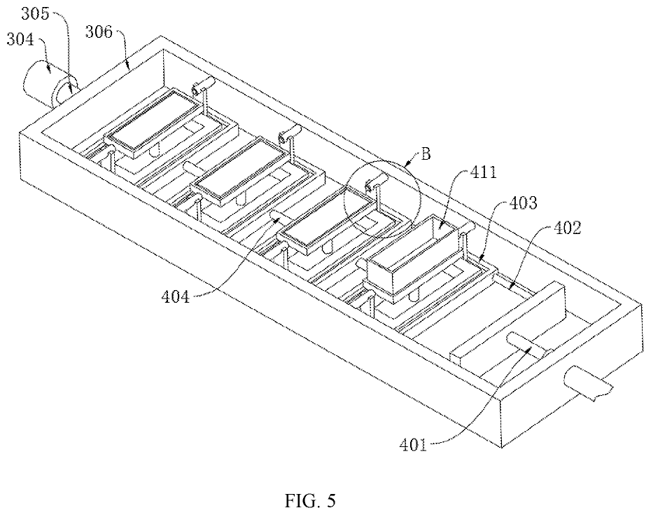

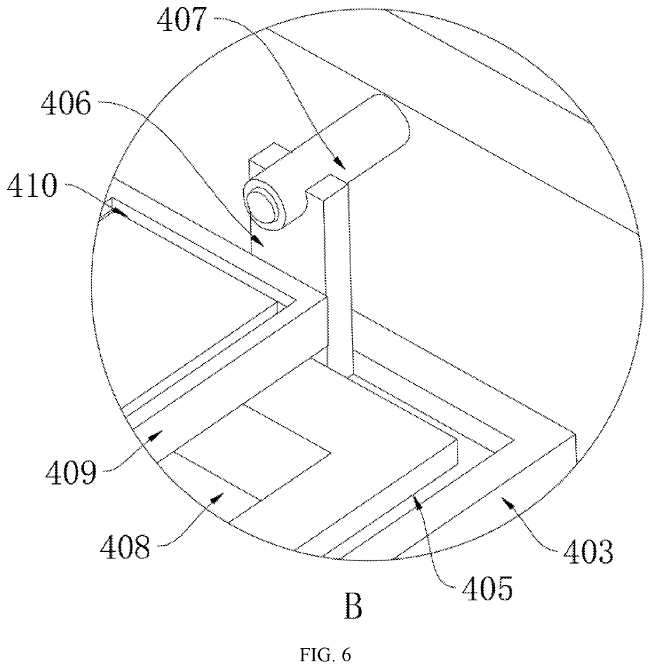

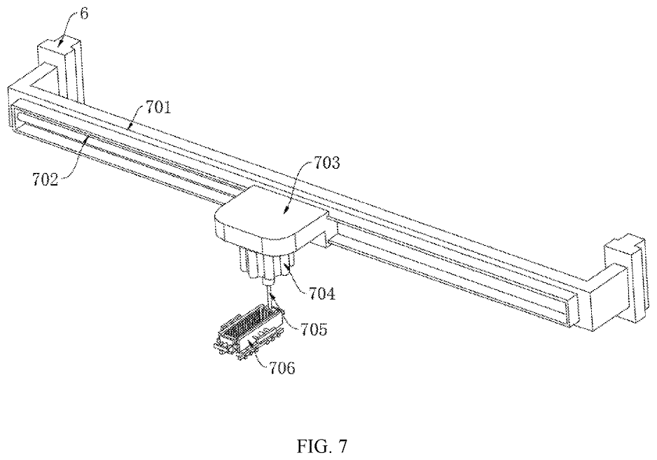

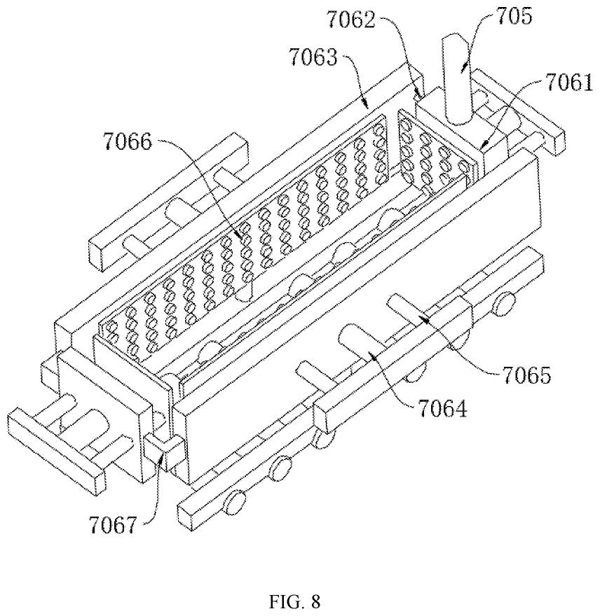

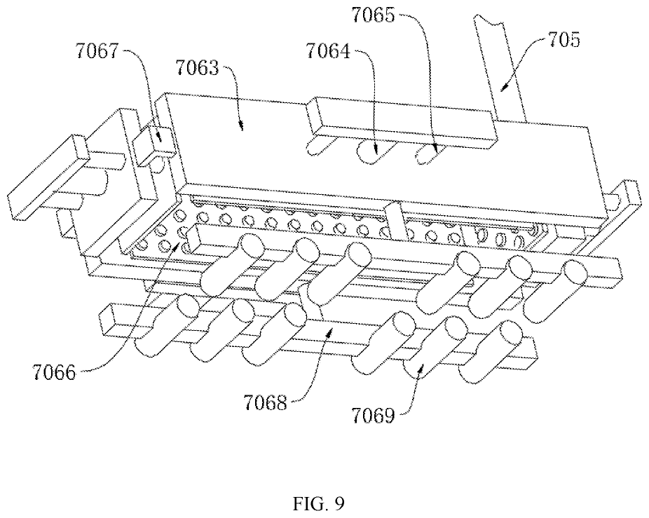

As shown in FIG. 1-FIG. 9, the present disclosure provides a technical scheme: including the apparatus 1, the apparatus 1 is set as a concrete masonry machine;
the first connecting frame 2, the first connecting frame 2 is installed outside the apparatus 1, two first connecting frames 2 are symmetrically set;
the chute 5, the chute 5 is opened inside the apparatus 1, and two chutes 5 are opened and symmetrically set;
the first chute board 6, the first chute board 6 is equipped with a power system inside the first chute board 6, the first chute board 6 is sliding connected to the interior of the chute 5, and two first chute boards 6 are symmetrically set;
the moving mechanism 3, the moving mechanism 3 and the first connecting frame 2 are connected, the moving mechanism 3 includes the second chute board 301 and the third chute board 303; the interior of the third chute board 303 is equipped with a power system, the exterior of the second chute board 301 and the third chute board 303 are equipped with a moving frame 306, the second chute board 301 and the third chute board 303 are used to control the moving frame 306 into and out of the apparatus 1;
the placing mechanism 4, the placing mechanism 4 is connected to the moving mechanism 3, the placing mechanism 4 includes the placing frame 403, the interior of the placing frame 403 is provided with a fixed groove 408, and the interior of the fixed groove 408 is installed with the first lifting frame 409, the first lifting frame 409 is composed of an electric push rod in the vertical direction and a bench;
the processing mechanism 7, the processing mechanism 7 is connected to the first chute board 6, the processing mechanism 7 includes the mobile station 703, the fifth push rod 705 is set under the mobile station 703, and the fifth push rod 705 is set as the electric push rod, the contact component 706 is installed at the bottom of the fifth push rod 705, and the fifth push rod 705 is used to control the contact component 706 to contact with the placing mechanism 4.

Before using the device, the position of the placing mechanism 4 is adjusted, so that the placing mechanism 4 is in a position away from the apparatus 1, and the release agent is manually applied inside the mold. Then the position of placing mechanism 4 is adjusted, and the placing mechanism 4 is moved to the lower part of the treatment mechanism 7, after manual coal gasification, the ash slag concrete raw material is placed in the placing mechanism 4, and the raw material is vibrated by the treatment mechanism 7. The position of the placing mechanism 4 is adjusted, and the placing mechanism 4 drives the raw material into the apparatus 1, the apparatus 1 is started to carry out the concrete block work. After the work is completed, the position of the placing mechanism 4 is adjusted. The placing mechanism 4 drives the raw material to move below the treatment mechanism 7, and the raw material is vibrated by the treatment mechanism 7. Then, the position of the placing mechanism 4 is adjusted, the placing mechanism 4 moves away from the apparatus 1, the forklift carrying the block is placed under the placing mechanism 4, and the moving mechanism 3 cooperates with the placing mechanism 4 to control the turnover of raw materials and the discharge work.

The moving mechanism 3 also includes:
the telescopic rod 302, the telescopic rod 302 is set as the electric push rod, and the telescopic rod 302 is installed between the second chute board 301 and the third chute board 303;
the first outer ring 304, two first outer rings 304 are provided; one of the first outer rings 304 is installed outside the second chute board 301, the other first outer ring 304 is installed outside the third chute board 303, and the first outer ring 304 is set to be made of rubber material;
the connecting pipe 305, the connecting pipe 305 is made of rubber material, and two connecting pipes 305 are provided, two connecting pipes 305 are respectively connected to the interior of two first outer rings 304, and the connecting pipe 305 is connected to the moving frame 306;
the connecting shaft 307, the connecting shaft 307 is connected to the moving frame 306;
the fourth chute board 309, the fourth chute board 309 is in a sliding connection to the interior of the first connection frame 2, and two fourth chute boards 309 are provided;
the second outer ring 308, the second outer ring 308 is installed outside the fourth chute board 309, the connecting shaft 307 is connected to the interior of the second outer ring 308 in a manner of rotation, and the second outer ring 308 is made of rubber material;
the channel 310, the channel 310 is opened in the interior of the connecting frame;
the mounting frame 311, the mounting frame 311 is installed outside the connecting frame;
the first motor cabinet 312, the first motor cabinet 312 is set above the mounting frame 311, the first motor is set inside the first motor cabinet 312, and the first motor is set as a servo motor.

The first push rod 313, the first push rod 313 is set as an electric push rod, and the first push rod 313 is connected to the output end of the first motor.

Before using the apparatus, the power system in the third chute board 303 is adjusted, so that the third chute board 303 is in the farthest position from the apparatus 1 in the connecting frame, at this time, the worker adjusts the placing mechanism 4 and applies the release agent to the interior of the mold.

Then the power system in the third chute board 303 is adjusted, the third chute board 303 drives the telescopic rod 302, the second chute board, two connecting tubes 305 and two moving frames 306 to move to the bottom of the processing mechanism 7, and then the workers place the raw materials in the mold, and the processing mechanism 7 vibrates the raw materials.

Then, the power system in the third chute board 303 is adjusted, the third chute board 303 drives the telescopic rod 302, the second chute board, two connecting pipes 305, and two moving frames 306 to move to the interior of the apparatus 1, and the apparatus 1 carries out the block forming work on the raw materials.

Then the power system in the third chute board 303 is adjusted, the third chute board 303 drives the telescopic rod 302, the second chute board, two connecting tubes 305, and two moving frames 306 to move to the bottom of the processing mechanism 7, the processing mechanism 7 is used to vibrate the raw materials to promote the demoulding of the raw materials.

Then the power system in the third chute board 303 is adjusted. The third chute board 303 drives the telescopic rod 302, the second chute board, two connecting tubes 305, and two moving frames 306 to move away from the apparatus 1. The forklift that undertakes the block is placed under the placing mechanism 4, and the moving mechanism 3 cooperates with the placing mechanism 4 to control the turnover of the raw material and the discharge work.

When the material is discharged, the first push rod 313 begins to move, the first push rod 313 is gradually stuck into the connecting pipe 305, and the first motor in the first motor cabinet 312 is opened. The first motor drives the first push rod 313 to deflect, the first push rod 313 drives the connecting pipe 305, the moving frame 306, and the placing mechanism 4 to deflect until the opening of the moving frame 306 is downward, and the block demoulding work is carried out with the placing mechanism 4.

By setting the moving mechanism 3, the position and angle of the moving frame 306 and the raw material are adjusted. The positions of applying the release agent, cloth, molding, and discharge are set separately to provide workers with working space. The first motor controls the deflection of the moving frame 306, which can control the opening direction of the moving frame 306, and then control the discharge position of the block.

The placing mechanism 4 also includes:
the second push rod 401, the second push rod 401 is set as an electric push rod, and the second push rod 401 is installed inside the moving frame 306;
the moving frame 402, the moving frame 402 is connected to the telescopic end of the second push rod 401, the moving frame 402 is connected to the placing frame 403, and multiple placing frames 403 are provided;
the adjusting rod 404, the adjusting rod 404 is set to a rod that can manually adjust the length, and the adjusting rod 404 is installed between two moving frames 402;
the first groove 405, the first groove 405 is opened inside the placing frame 403;
the supporting plate 406, the supporting plate 406 is installed inside the first groove 405, and two supporting plates 406 are symmetrically set;
the third push rod 407, the third push rod 407 is installed inside the placing frame 403, and the telescopic end of the third push rod 407 is installed with a pad;
the second groove 410, the second groove 410 is opened in the interior of the first lifting frame 409;
the lower die 411, the lower die 411 is installed inside the second groove 410, and the two components are locked, the lower die 411 is set as a frame-type lower die 411 without a top and bottom.

Before using the apparatus, the second push rod 401 is started, the second push rod 401 drives the moving frame 402 and the placing frame 403 to move, the electric push rod in the vertical direction in the first lifting frame 409 is started, and the electric push rod drives the bench to move upward, the release agent is applied on the upper surface of the bench manually, and after the release agent is formed. The multiple lower dies 411 that have been formed after applying the release agent are manually installed into the interior of multiple second grooves 410.

As the moving frame 306 moves to the bottom of the processing mechanism 7, the raw material is manually placed in the lower die 411 by the worker, and then the processing mechanism 7 is adjusted to vibrate the raw material.

As the moving frame 306 moves to the inside of the apparatus 1, the electric push rod in the vertical direction in the first lifting frame 409 is adjusted to the initial state, and the third push rod 407 on both sides is opened, the third push rod 407 and the pad pass through the support plate 406, the pad contacts the outer surface of the lower die 411 and contacts and fixes the lower die 411, subsequently, the apparatus 1 is adjusted to form the block.

As the moving frame 306 moves to the bottom of the processing mechanism 7, the electric push rod in the vertical direction of the first lifting frame 409 is started, and the electric push rod drives the bench to move upward, the raw materials are vibrated by the processing mechanism 7 to promote the separation of the block from the lower die 411 and the bench. Then, the electric push rod in the vertical direction of the first lifting frame 409 is adjusted to the initial state; at this time, the upper surface of the platform is flush with the upper surface of the placing frame 403.

As the moving frame 306 deflects to the opening downward, the electric push rod in the vertical direction in the first lifting frame 409 is adjusted to the reciprocating motion mode, which promotes the block to leave the bench and the lower die 411, and promotes the block to fall on the forklift. Then the moving frame 306 is adjusted to the opening upward, the second push rod 401 is adjusted to the initial state, the second push rod 401 drives the moving frame 402, and the placing frame 403 returns to the original position, and the placing frame 403 drives the first lifting frame 409 to return to the original position. At this time, the bench in the first lifting frame 409 is separated from the lower die 411, and the lower die 411 is fixed between the two pads, which is convenient for workers to deal with the lower die 411 and the bench separately.

By setting the placing mechanism 4, the integrated mold is divided into a topless bottomless frame lower die 411, and a bench that can rise and fall, and the frame lower die 411 and the bench are treated with brush release agent, respectively. In the existing block apparatus, an integrated mold is set up. When applying the release agent, the release agent in the mold gradually flows to the bottom, resulting in too much release agent at the bottom of the mold, which easily leads to problems at the bottom of the block forming. Therefore, a block mold composed of a topless and bottomless frame lower die 411, and a bench capable of lifting is set up, and the upper surface of the bench and the frame lower die 411 are respectively painted by the workers. The release agent is formed, and the component of the two is completed to avoid the above phenomenon.

The processing mechanism 7 also includes:

The second connecting frame 701, the second connecting frame 701 and the first sliding plate 6 are connected, and the mobile station 703 is in a sliding connection inside the second connecting frame 701;
the fourth push rod 702, the fourth push rod 702 is set as an electric push rod, the fourth push rod 702 is installed inside the second connecting frame 701, and the telescopic end of the fourth push rod 702 is connected to the mobile platform 703.

The second motor cabinet 704 is installed at the bottom of the mobile station 703, the second motor cabinet 704 is equipped with a second motor, the second motor is set as a vibration motor, and the fifth push rod 705 is connected to the output end of the second motor.

After the feeding and the forming work, the stroke of the fourth push rod 702 is adjusted. The fourth push rod 702 drives the mobile station 703 to move inside the second connecting frame 701, and then the fifth push rod 705 is opened. The fifth push rod 705 drives the contact component 706 to move downward, so that the contact component 706 contacts the lower die 411 and the bench, and then the second motor is opened to transmit the vibration to the lower die 411 and the bench.

By setting the treatment mechanism 7, the concrete is placed between the lower die 411 and the bench, and the treatment mechanism 7 and the contact component 706 are used to vibrate the lower die 411 and the bench to promote the discharge of bubbles in the concrete. After the concrete is processed by block forming, the processing mechanism and contact component 706 are used to promote the vibration of the lower die 411 and the bench, and promote the separation of the block from the lower die 411 and the bench.

The contact component 706 includes:

The connecting plate 7061, the connecting plate 7061 is connected to the telescopic end of the fifth push rod 705, and two connecting plates 7061 are provided;
the sixth push rod 7062, the sixth push rod 7062 is set as an electric push rod, two sixth push rods are provided, and two sixth push rods 7062 are installed on both sides of the connecting plate 7061;
the side plate 7063, the side plate 7063 is connected to the telescopic end of the sixth push rod 7062, and the exterior of the side plate 7063 is equipped with an electric push plate 7064;
the connecting rod 7065, the connecting rod 7065 is connected to the electric push plate 7064, the external installation of the connecting rod 7065 is the contact plate 7066, multiple bumps are evenly set at the exterior of the contact plate 7066, the count of the electric push plate 7064, the connecting rod 7065 and the contact plate 7066 are four, respectively.

The expansion plate 7067, the expansion plate 7067 is installed outside the side plate 7063, and the expansion plate 7067 is connected to the connecting plate 7061, which is far away from the fifth push rod 705.

The second lifting frame 7068, the second lifting frame 7068 is composed of an electric push rod and a table plate in the vertical direction, and the second lifting frame 7068 is installed at the bottom of the side plate 7063.

The connecting column 7069, the connecting column 7069 is installed at the bottom of the second lifting frame 7068, and multiple connecting columns 7069 are set.

Before using the apparatus, the sixth push rod 7062 on both sides is started. The two sixth push rods 7062 drive the two side plates 7063 to move away from the connecting plate 7061, and the fifth push rod 705 is started, the fifth push rod 705 drives the contact component 706 to move downward until the side plate 7063 is on both sides of the lower die 411. Then the sixth push rod 7062 is adjusted to the initial state, and the sixth push rod 7062 drives the two side plates 7063 to move closer to the lower die 411. The electric push rod in the four electric push plates 7064 and the two second lifting frames 7068 are adjusted to a reciprocating motion mode. The electric push plate 7064 drives the connecting rod 7065 and the contact plate 7066 for reciprocating motion. Meanwhile, the vibration motor is turned on, the convex outside the contact plate 7066 begins to vibrate and repeatedly hits the lower die 411, the second lifting frame 7068 drives the connecting column 7069 to repeatedly vibrate and hit the bench at the bottom of the bench. The lower die 411, the bench, and the raw material are vibrated.

By setting the contact component 706, after the concrete cloth, the uniform vibration collision work is carried out around the lower die 411 and the bottom of the bench to promote the uniform distribution of the concrete and promote the discharge of bubbles. After the block is formed, the uniform vibration collision work is carried out around the lower die 411 and the bottom of the bench to promote the separation of the block from the lower die 411 and the bench.

Working principle: Before using the apparatus, the power system in the third chute board 303 is adjusted so that the third chute board 303 is in the farthest position from the apparatus 1 in the connecting frame. At this time, the worker adjusts the placing mechanism 4, and applies the internal release agent of the lower die 411.

Before using the apparatus, the second push rod 401 is opened, the second push rod 401 drives the moving frame 402 and the placing frame 403 to move, and the electric push rod in the vertical direction of the first lifting frame 409 is opened. The electric push rod drives the bench to move upward, and the release agent is manually applied to the upper surface of the bench. After the release agent is formed, the lower die 411 that has been coated and formed by the release agent is manually installed inside multiple second grooves 410.

Then the power system in the third chute board 303 is adjusted, the third chute board 303 drives the telescopic rod 302, the second chute board, two connecting pipes 305 and two moving frames 306 to move to the bottom of the processing mechanism 7, the raw material is then placed in the lower die 411 by the worker, and the raw material is subjected to vibration treatment by the processing mechanism 7.

Before using the apparatus, the sixth push rod 7062 on both sides is started, two sixth push rods 7062 drive the two side plates 7063 to move away from the connecting plate 7061, and the fifth push rod 705 is opened, the fifth push rod 705 drives the contact component 706 to move downward until the side plate 7063 is on both sides of the lower die 411. Then the sixth push rod 7062 is adjusted to the initial state, and the sixth push rod 7062 drives the two side plates 7063 to move closer to the lower die 411. The electric push rod in the four electric push plates 7064 and the two second lifting frames 7068 is adjusted to the reciprocating motion mode. The electric push plate 7064 drives the connecting rod 7065 and the contact plate 7066 for reciprocating motion. Meanwhile, the vibration motor is turned on. The convex outside the contact plate 7066 begins to vibrate and repeatedly hits the lower die 411. The second lifting frame 7068 drives the connecting column 7069 to repeatedly vibrate and hit the bench at the bottom of the bench. The lower die 411, the bench, and the raw material are vibrated.

Then, the power system in the third chute board 303 is adjusted, the third chute board 303 drives the telescopic rod 302, the second chute board, two connecting pipes 305, and two moving frames 306 to move inside the apparatus 1, and the apparatus 1 carries out the block forming work on the raw materials. As the moving frame 306 moves to the inside of the apparatus 1, the electric push rod in the vertical direction in the first lifting frame 409 is adjusted to the initial state, and the third push rod 407 on both sides is started, the third push rod 407 and the pad pass through the support plate 406, the pad contacts the outer surface of the lower die 411 and contacts and fixes the lower die 411. Subsequently, the apparatus 1 is adjusted to form the block.

Then the power system in the third chute board 303 is adjusted, the third chute board 303 drives the telescopic rod 302, the second chute board, two connecting tubes 305, and two moving frames 306 to move to the bottom of the processing mechanism 7. The processing mechanism 7 is used to perform the same vibration treatment on the raw materials to promote the demoulding of the raw materials.

As the moving frame 306 moves to the bottom of the processing mechanism 7, the electric push rod in the vertical direction of the first lifting frame 409 is started, and the electric push rod drives the bench to move upward. The raw materials are vibrated by the processing mechanism 7 to promote the separation of the block from the lower die 411 and the bench. Then, the electric push rod in the vertical direction of the first lifting frame 409 is adjusted to the initial state. At this time, the upper surface of the platform is flush with the upper surface of the placing frame 403.

Then the power system in the third chute board 303 is adjusted, the third chute board 303 drives the telescopic rod 302, the second chute board, two connecting tubes 305, and two moving frames 306 to move away from the apparatus 1. The forklift that undertakes the block is placed under the placing mechanism 4, and the moving mechanism 3 cooperates with the placing mechanism 4 to control the turnover of the raw material and the discharge work.

When the material is discharged, the first push rod 313 is started, the first push rod 313 is gradually stuck into the connecting pipe 305, and the first motor in the first motor cabinet 312 is opened. The first motor drives the first push rod 313 to deflect. The first push rod 313 drives the connecting pipe 305, the moving frame 306, and the placing mechanism 4 to deflect until the opening of the moving frame 306 is downward, and the block demoulding work is carried out with the placing mechanism 4.

As the moving frame 306 deflects to the opening downward, the electric push rod in the vertical direction in the first lifting frame 409 is adjusted to the reciprocating motion mode, which promotes the block to leave the bench and the lower die 411, and promotes the block to fall on the forklift. Then the moving frame 306 is adjusted to the opening upward, the second push rod 401 is adjusted to the initial state, the second push rod 401 drives the moving frame 402, and the placing frame 403 to return to the original position, and the placing frame 403 drives the first lifting frame 409 to return to the original position. At this time, the bench in the first lifting frame 409 is separated from the lower die 411, and the lower die 411 is fixed between the two pads, which is convenient for workers to deal with the lower die 411 and the bench separately.

Obviously, the described embodiments are only part of the embodiments of the present disclosure, not all of the embodiments. Based on the embodiments in this present disclosure, all other embodiments obtained by ordinary technicians in this field and related fields without making creative labor should belong to the scope of protection of this present disclosure. The structure, device, and operation method, which are not specifically described and explained in this present disclosure, are implemented in accordance with the conventional means in this field if there is no special description and limitation.

What is claimed is:

1. A concrete block apparatus for ash slag after coal gasification, comprising an apparatus (1);
a first connecting frame (2), the first connecting frame (2) is installed outside the apparatus (1);
a chute (5), the chute (5) is opened inside the apparatus (1);
a first chute board (6), the first chute board (6) is in a sliding connection to an interior of the chute (5);
a moving mechanism (3), the moving mechanism (3) is connected to the first connecting frame (2); the moving mechanism (3) comprises a second chute board (301) and a third chute board (303); exteriors of the second chute board (301) and the third chute board (303) are equipped with a moving frame (306); the second chute board (301) and the third chute board (303) are configured to control the moving frame (306) to enter and exit the apparatus (1);
a placing mechanism (4), the placing mechanism (4) is connected to the moving mechanism (3); the placing mechanism (4) comprises a placing frame (403); a fixed groove (408) is arranged inside the placing frame (403), and a first lifting frame (409) is installed inside the fixed groove (408); and
a processing mechanism (7), the processing mechanism (7) is connected to the first chute board (6), the processing mechanism (7) comprises a mobile station (703); a fifth push rod (705) is arranged below the mobile station (703); a bottom of the fifth push rod (705) is equipped with a contact component (706), the fifth push rod (705) is configured to control a contact between the contact component (706) and the placing mechanism (4).

2. The concrete block apparatus for ash slag after coal gasification according to claim 1, wherein the moving mechanism (3) also comprises:
a telescopic rod (302), the telescopic rod (302) is installed between the second chute board (301) and the third chute board (303);
a first outer ring (304), two first outer rings (304) are provided, one of the first outer rings (304) is installed outside the second chute board (301), and the other first outer ring (304) is installed outside the third chute board (303); and
a connecting tube (305), two connecting tubes (305) are provided, two connecting tubes

(305) are respectively connected inside two first outer rings (304) in a manner of rotation, and the connecting tube (305) is connected to the moving frame (306).

3. The concrete block apparatus for ash slag after coal gasification according to claim 2, wherein the moving mechanism also comprises:
a connecting shaft (307), the connecting shaft (307) is connected to the moving frame (306);
a fourth chute board (309), the fourth chute board (309) is connected to an interior of the first connecting frame (2), and two fourth chute boards (309) are provided; and
a second outer ring (308), the second outer ring (308) is installed outside the fourth chute board (309), and the connecting shaft (307) is connected inside the second outer ring (308) in a manner of rotation.

4. The concrete block apparatus for ash slag after coal gasification according to claim 3, wherein the moving mechanism (3) also comprises:
a channel (310), the channel (310) is opened in the interior of the connecting frame;
a mounting frame (311), the mounting frame (311) is installed outside the connecting frame;
a first motor cabinet (312), the first motor cabinet (312) is arranged above the mounting frame (311), and the first motor is arranged inside the first motor cabinet (312); and
a first push rod (313), the first push rod (313) is connected to an output end of the first motor.

5. The concrete block apparatus for ash slag after coal gasification according to claim 1, wherein the placing mechanism (4) also comprises:
a second push rod (401), the second push rod (401) is arranged inside the moving frame (306);
a moving frame (402), the moving frame (402) is connected to a telescopic end of the second push rod (401), the moving frame (402) is connected to the placing frame (403), and multiple placing frames (403) are provided; and
an adjusting rod (404), the adjusting rod (404) is installed between two moving frames (402).

6. The concrete block apparatus for ash slag after coal gasification according to claim 5, wherein the placing mechanism (4) also comprises:
a first groove (405), the first groove (405) is opened inside the placing frame;
a supporting plate (406), the supporting plate (406) is installed in an interior of the first groove (405), and two supporting plates (406) are provided in a symmetrical setting;
a third push rod (407), the third push rod (407) is installed inside the placing frame (403), and a telescopic end of the third push rod (407) is installed with a pad;
a second groove (410), the second groove (410) is opened in an interior of the first lifting frame (409); and
a lower die (411), the lower die (411) is installed inside the second groove (410).

7. The concrete block apparatus for ash slag after coal gasification according to claim 1, wherein the processing mechanism (7) also comprises:
a second connecting frame (701), the second connecting frame (701) is connected to the first sliding plate (6), and the mobile station (703) is in a sliding connection inside the second connecting frame (701);
a fourth push rod (702), the fourth push rod (702) is installed inside the second connecting frame (701), and a telescopic end of the fourth push rod (702) is connected to the mobile station (703); and
a second motor cabinet (704), the second motor cabinet (704) is installed at a bottom of the mobile station (703), the second motor (704) is arranged inside the second motor cabinet, and a fifth push rod (705) is connected to an output end of the second motor.

8. The concrete block apparatus for ash slag after coal gasification according to claim 7, wherein the contact component (706) comprises:
a connecting plate (7061), the connecting plate (7061) is connected to a telescopic end of the fifth push rod (705);
a sixth push rod (7062), two sixth push rods (7062) are arranged, and the two sixth push rods (7062) are respectively installed on both sides of the connecting plate (7061);
a side plate (7063), the side plate (7063) is connected to a telescopic end of the sixth push rod (7062), and an exterior of the side plate (7063) is equipped with an electric push plate (7064); and
a connecting rod (7065), the connecting rod (7065) is connected to an electric push plate (7064), an exterior of the connecting rod (7065) is equipped with a contact plate (7066), and an exterior of the contact plate (7066) is provided with a convex.

9. The concrete block apparatus for ash slag after coal gasification according to claim 8, wherein the contact component (706) also comprises:
an expansion plate (7067), the expansion plate (7067) is installed on an exterior of the side plate (7063);
a second lifting frame (7068), the second lifting frame (7068) is installed at a bottom of the side plate (7063); and
a connecting column (7069), the connecting column (7069) is installed at a bottom of the second lifting frame (7068), and multiple connecting columns (7069) are provided.
